(19) United States
(12) Patent Application Publication
(10) Pub. No.: US 2005/0158162 A1
(43) Pub. Date: Jul. 21, 2005

(54) Wheel-lift device with tongue for towing vehicles-(4)

(76) Inventor: Arden Royce Shubert, Fort Collins, CO (US)

Correspondence Address: Arden Royce Shubert, 1920 Sheely Drive, Fort Collins, CO, 80526, US

(21) Appl. No.: 11/081,441

(22) Filed: Mar. 16, 2005

Related U.S. Application Data
(63) Continuation-in-part of application No. 10/294,258, filed on Nov. 14, 2002.

(51) Int. Cl. B65G 1/00

(52) U.S. Cl. 414/563

(57) ABSTRACT

A rigid wheel-lift device, assembled from components, for towing any vehicle or machine having at least two axles and four or more wheels. Particularly a device having parallel beams holding an axle that, when assembled with a tongue, becomes a rigid appendage to the vehicle. Tongue incorporates a hinged arm for raising the vehicle to be towed into position for towing on its trailing axle. A tow truck needs to be equipped only with an adequate hitch fixed to a chassis of adequate capacity.

### BACKGROUND OF THE INVENTION

Wheel-lift towing of vehicles has a history of less than four decades. Wagner, U.S. Pat. No. 3,182,829, May 1965, gave us a vehicular lifting yoke. His yoke taught us to use the axle of the towed vehicle as the horizontal axis for articulation between the towed and towing vehicle. It remains common practice to date.

That design has an inherent problem. The location of the horizontal pivot determines the location of where the weight of the towed vehicle is transferred to the tow truck. Truck manufacturers prefer that a truck's load be carried between the axles or close to the rear axle. A recommended ratio of no more than forty percent of cargo weight should be carried behind the axle. This design carries all of the cargo weight some distance behind the axle and the weight of the wheel-lift equipment as well is carried behind the truck's axle in most designs.

Earlier wreckers, especially before about 1980, used a tow bar or a sling that attached to the bumper or the end of the frame of the towed vehicle. The weight of the vehicle was carried by the wrecker at the tow bar that had a working position of several feet behind the end of the truck. In comparison that is about half the distance from the axle that many wheel-lifts carry their load. To compensate for this shift of the load rearward, wreckers are generally at least one and a half times the length of earlier tow trucks and weigh substantially more.

State commercial drivers license manuals teach drivers that they are responsible for their load and that poor distribution of weight can make vehicle handling unsafe. Tow truck operators are generally required to have commercial drivers licenses and to know these rules. It seems inevitable that towmen will be summoned to court sometime in the future for knowingly operating unsafe vehicles.

The industry seems aware of the challenges it faces carrying towing loads far behind tow trucks' rear axles but it appears to have not yet found a solution that addresses the weight transfer problem. An example appears in the Winter 2002 edition of the Write Carrier & Wrecker Quarterly, Volume 11, Number 1, Page 20, a publication of the Jerr-Dan Corporation, a major manufacturer of towing equipment.

This article describes a user's need for equipment to tow a fire truck with a front axle weight of 21,350 pounds, a front axle set back of 10 feet from the front bumper, and the fire truck having a bucket and snorkel assembly that extends 7 feet ahead of the front bumper. The fire trucks have low hanging components within the underbelly of the fire truck that the towing boom needed to pass under without contact when turning. The manufacturer only approves the axle as a pickup point. The fire trucks are too high to transport on trailers.

This customer's problem invites a comparison between the industry's state of art and the present invention. Their solution was to use a modified heavy-duty Under-lift carrying the fire truck by the axle using a four stage rigid boom extending behind the truck's tri-axles. The 21,350 pound front axle load of the fire truck is carried about 20 feet behind the center of the tow truck's rear suspension. The rigid lifting boom acts as a lever increasing the 21,350 pound axle weight on the Under-lift's axles. Wrecker trucks have a high tare weight. The combined load exceeds the tri-axle legal load weight. The article acknowledges that this combination will be an oversize, over-height, and overweight load.

The present invention shifts both horizontal and vertical axes between the tow truck and the fire truck from the rear of the lifting arm to the front of that arm. The action of the lever on this wheel-lift hitch device arm transfers most of the front axle weight to the tow truck, but a percentage of that weight will be transferred to the rear axles of the towed unit. In this example the fire truck could be towed using the present invention by a tandem axle tractor equipped with a pintle hook hitch and be of legal axle weight on the tow truck's axles. The present invention has no arm that pivots under the load. The load may be carried lower because less clearance beneath the truck is required and the towed load may be under legal height limits. A shorter tow truck can be used because it is not necessary to have excessive tow truck length to counterbalance a load carried far behind the axles of the tow truck The combination can be within legal length requirements.

An additional problem with the present designs of wheel-lift tow trucks of all sizes and classes is that all carry the load at the end of a boom behind the truck axle. The boom serves as a lever. A lever amplifies motion and force. That amplified motion can cause movement and forces in excess of design capability of the towed vehicle. An irregular or undulating road surface can cause extreme vertical movement in the suspension of the towed vehicle carried on a wheel-lift and retained to that boom and can result in damage to that vehicle.

To avoid some of this damage users can raise the boom to relatively high angles from horizontal to provide more clearance between the boom, its pivot, and drive train components of the towed vehicle. This action causes a different problem. Many tow truck designs advertise a wheel-lift boom angle of 10 to 15 degrees above horizontal. When a boom is raised to that angle, the pivot pin between the boom and the transverse bar of the wheel-lift also tilts forward at a like angle. The forward tilt of the transverse bar's pivot pin causes the towed vehicle to warp in a turn in relation to the attitude of the tow truck. The actual warp between the inside and outside ends of the transverse bar in a 45 degree turn may be 12 inches or more when the boom is carried at these angles. Cullum, U.S. Pat. No. 5,709,522, January 1998, introduced a double pivot crossbar “capable of rotational movement in both horizontal and vertical planes permitting stress reduction in both the tow truck assembly and the tow truck chassis . . . .” Presumably it may also reduce stress to the towed vehicle that is generally less strong than towing equipment.

Available alternatives to a wheel-lift tow truck are limited. Car carriers are widely used by professional towing operators. Their size is generally a disadvantage. Three car lengths of space are generally required to load or unload a car carrier compared to two car lengths of space with most wheel-lift trucks. That space requirement can limit the efficiency of a car carrier in an urban environment. A second problem with car carriers is the difficulty of damage-free loading of a vehicle with front wheels locked at an angle. Force rather than finesse generally prevails and the locked vehicle is dragged onto a truck causing strain on mechanical components. Alm, U.S. Pat. No. 5,779,431, July 1998, introduced a wheel-loading device used on a car carrier body to facilitate damage-free loading. It appears to be the only wheel-lift design at this time that carries its load primarily between the axles of the truck during transport.

Car dollies also carry vehicles on their own wheels and suspension. Car dollies have only limited capabilities for handling damaged or inoperable vehicles. Most designs include two vertical axes, one at the hitch and a second at the wheels of the towed vehicle. Few operators are able to back up such a combination and commercial use is therefore limited.

A wheel-lift device seldom seen in the United States is a truck mounted rotating boom equipped with a rotating lift frame at its outer end. The lift frame is maneuvered over the vehicle and wheel supports attached to the lift frame are placed under each wheel. The vehicle is then hoisted onto the truck body. It appears to be an especially efficient approach for the damage-free removal of illegally parked vehicles.

A different under-lift towing device is an alternative to the traditional wheel-lift or under-lift. Marketed under the trade name “Tru-Hitch”, it is an under-lift for heavy duty towing that uses the 5th wheel of a semi-truck tractor as the horizontal and vertical towing axes. It was introduced into the commercial market about 1990 and is a towing system that carries the weight of the towed vehicle above the axle of the tow truck. It lacks convenience for use in its method of attachment to the vehicle to be towed.

The automotive wheel-lift has long been used as both horizontal and vertical axes between the towed vehicle and the tow truck. There appears to be no precedent for a wheel-lift to not use the vehicle wheels as a horizontal axis and instead immobilize it and use the immobilized axle to support a fixed tongue. A wheel-lift hitch does not appear to have been used to transfer the horizontal and vertical axes to the front by a tongue to a hitch ahead of the towed vehicle. There is no precedent for a wheel-lift device that is assembled at the vehicle axle creating a tongue with which to tow that vehicle and then carrying it on its own wheels and suspension.

Devices for lifting a heavy tongue from the ground into a towing hitch on a truck are readily available and in widespread use, especially in the modular and mobile home transporting business. Charles Weber, U.S. Pat. No. 4,000,911, January 1977, introduced a hitch head that was hydraulically adjustable laterally, vertically, and longitudinally. Randall Weber, U.S. Pat. No. 4,946,182, August 1990, followed with an even more versatile boom type hitch. Those, and other hitches with similar capability, are readily adaptable for use with the present invention. Strap winches integral within small booms will offer a convenient and lightweight solution for raising the tongue to a hitch for many users.

The present invention is usually attached to the vehicle to be towed before it is attached to the tow truck so this hitch device conforms to all terrain conditions. The tow truck or the carrier attaches to the hitch device. Powered wheel-lifts often cause damage. Young, U.S. Pat. No. 5,951,235, September 1999, describes problems that all in the industry face and offers a powered solution to it. The present invention, a manually maneuvered hitch device, is powerless to cause damage to a vehicle and can perform similar tasks.

Under the best conditions tow truck operation is seldom without some physical effort. Sophisticated self-loading towing equipment requires the operator to check and perhaps secure the load before departing on a high-speed tow on public roadways. Most towing units still require installation of wheel chocks and retaining straps or chains. The present invention recognizes that fact and includes such tasks in the assembly of the wheel-lift hitch onto the vehicle to be towed. Many wreckers and tow trucks now carry towing dollies that require assembly, often at accident scenes. Light-duty embodiments of the present invention will be comparable in weight to the advertised weights of towing dollies and will require about the same time and effort to assemble.

It is understood that this device is adaptable to any hitch design that has an adequate vertical load rating in addition to adequate towing capacity. Pintle hooks and a variety of 5th wheel hitches are preferred over most ball hitches that are limited by low vertical load ratings. Gooseneck hitch adaptors can be used with models that have an adjustable length tongue and will offer better load transfer at some cost to convenience. Weight transfer hitches can be accommodated and truck mounted tongues are expected to be developed.

### BACKGROUND OF INVENTION—OBJECTS AND ADVANTAGES

The main object of this invention is to provide a wheel lift device that, without moving parts and when assembled around wheels on an axle of a vehicle, becomes an appendage to that vehicle which can be used as a tongue to tow the vehicle as a cart behind a tow truck and to carry that vehicle on its own suspension.

A second object of the invention is to introduce a universal wheel lift design that can be used to lift and carry one axle of almost all vehicles having at least 2 axles with wheels and tow that vehicle allowing it to ride on its own suspension.

A third object of the invention is to provide an automotive wheel lift device to the industry that is as easy to assemble as a car dolly regularly used by those in the industry and of comparable or less weight.

Another object of the invention is to introduce a wheel lift design that reduces the distance that the towing load is carried behind the axle of the tow truck thus providing safer and improved handling characteristics for the tow truck.

An additional object of the invention is to create a design that can be easily manufactured without specialized machinery.

A further object of the invention is to create a tool with simple and logical design, the proper use of which might be taught to almost any user without extensive repetition.

Additional objects and advantages of this invention will be set forth in the following description. They will in part be obvious from the description or may be learned by practice of the invention.

### SUMMARY

The present invention provides a wheel-lift hitch that is assembled around a vehicle axle for carrying that axle and serving as a tongue to tow that vehicle by a second vehicle.

### BRIEF DESCRIPTION OF THE SEVERAL VIEWS OF THE DRAWINGS

FIG. 1 is a perspective view of assembled wheel-lift device.

FIG. 2 is an exploded view of tongue assembly.

FIG. 3 is a perspective view of first and second sockets with first leg and first chain.

### REFERENCE NUMBERS USED IN DRAWINGS

| | |
|---|---|
| 20 - Wheel-lift Device | 22 - Hinged Arm Assembly |
| 24 - Tongue Assembly | 26 - First Beam Assembly |
| 28 - Second Beam Assembly | 30 - Hitch |
| 32 - First Arm | 34 - Hinge |
| 36 - Second Arm | 38 - Jack Ram |
| 40 - Jack Pump | 42 - Hydraulic Coupler |
| 44 - First Clevis Pin | 46 - Second Clevis Pin |
| 48 - First Arm Lock | 50 - Hitch Housing |
| 52 - Second Arm Lock | 54 - Channel |
| 56 - Web | 58 - Boss |
| 60 - Third Arm | 62 - Cleat |
| 64 - Latch Hole | 66 - First Chain Latch |
| 68 - First Hitch Pin | 70 - Tongue Brackets |
| 72 - First Socket | 74 - Anchor |
| 76 - Second Chain Latch | 78 - Second Pin Slots |
| 80 - Second Hitch Pin | 82 - First Leg |
| 84 - Second Socket | 86 - Third Chain Latch |
| 88 - Third Socket Assembly | 90 - Second Leg |
| 92 - Chain Eye | 94 - Chain Binder |
| 96 - First Chain | 98 - Second Chain |
| 100 - Second Arm Adjustment Holes | 102 - Skid Shoes |

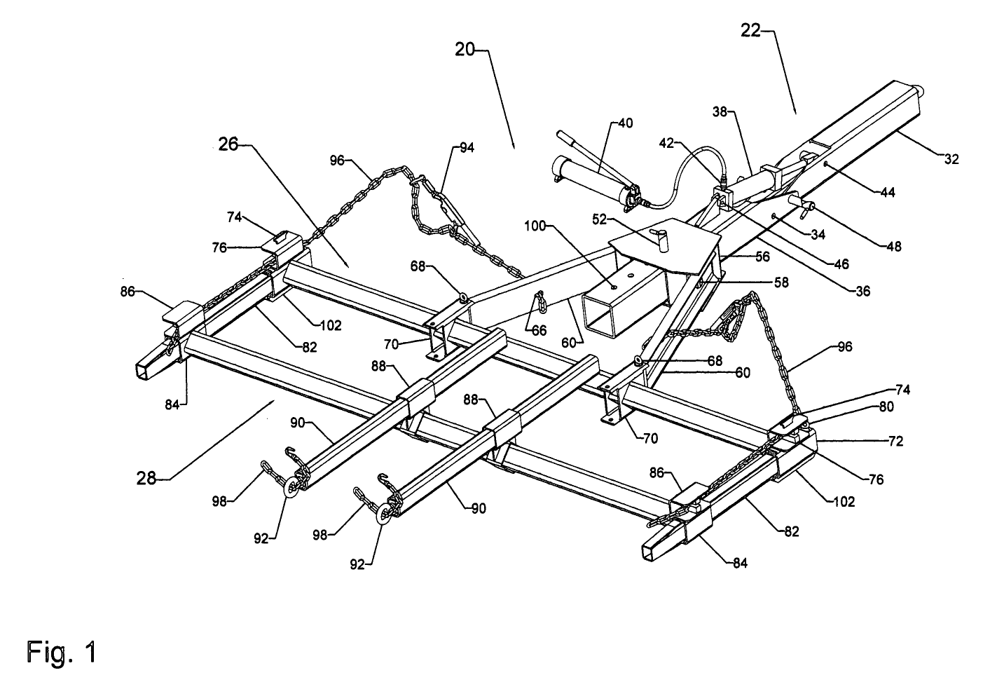

### DETAILED DESCRIPTION—FIGS. 1-3

Wheel-lift device (20) shown in FIG. 1 is intended for use with larger trucks and farm, utility, industrial, and construction equipment. It is assembled around an axle of a truck or machine to be towed, extending toward the front as a rigid tongue. Tongue assembly (24) is adjustable for length and, using a hinged arm, raises vehicle for towing. Wheel-lift device (20) extends rearward from axle, engaging frame of vehicle for securing device to vehicle. Weight of axle is carried by wheel-lift device (20) transferring most of axle's weight forward to hitch (30). Some axle weight is transferred rearward to trailing axle. Hitch (30) is both horizontal and vertical axes between units.

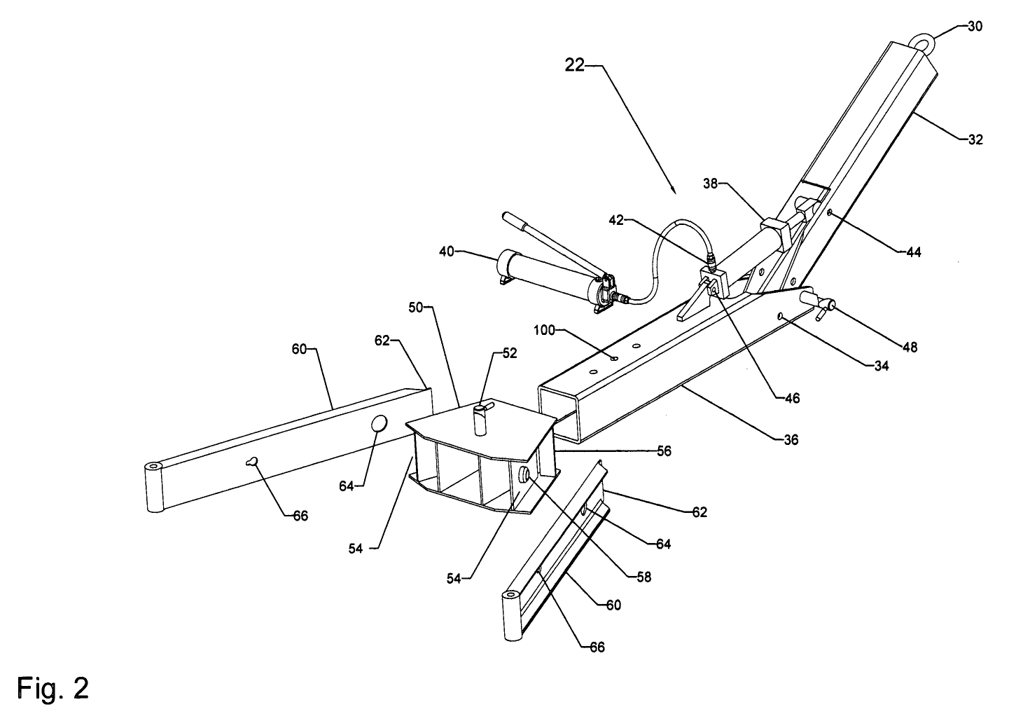

Hinged arm assembly (22) shown in FIG. 2 provides a means to raise vehicle for towing by using hitch (30) connected to a tow truck at its front as a first pivot. Jack ram (38) is extended to straighten hinged arm assembly (22) thereby raising vehicle axle, using vehicle's trailing axle as a second pivot.

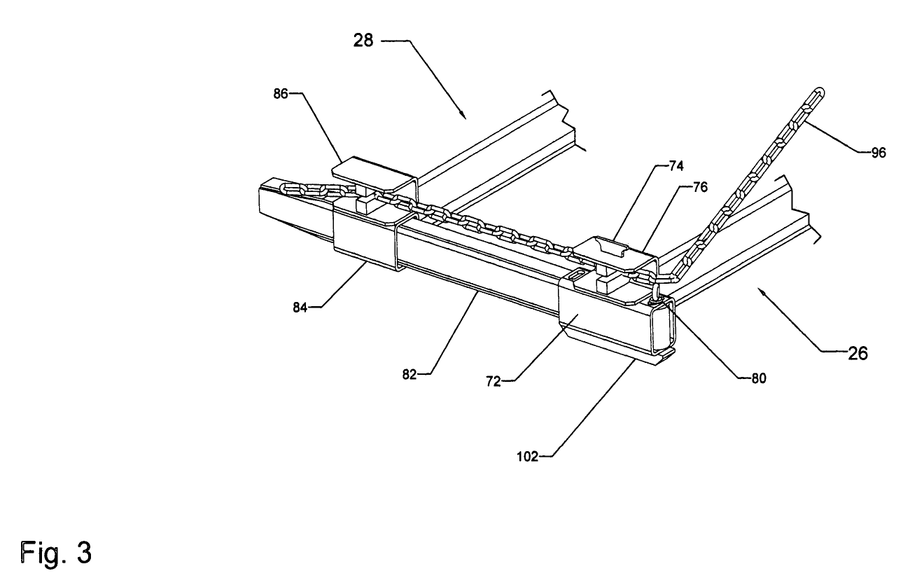

An axle of the truck or machine is captured between a first beam assembly (26) and a second beam assembly (28), beams held in place at axle by a combination of first legs (82) and first chains (96), illustrated in FIG. 3. First leg (82) holds general alignment between first socket (72) and second socket (84), held in position using the forward pair of second hitch pin slots (78) engaging second hitch pin (80). First chain (96) is secured within second chain latch (76) and third chain latch (86) holding first beam assembly (26) and second beam assembly (28) in position on first leg (82).

First beam assembly (26) can be made symmetrical front to rear. Second beam assembly (28) can also be made symmetrical. Third arms (60), first legs (82), and second legs (90) are the same left and right. This symmetry greatly simplifies assembly and use.

Tongue assembly (24) joins onto first beam assembly (26) by first connecting a third arm (60) to a tongue bracket (70) using first hitch pin (68). Trapezoidal-shaped hitch housing (50) is attached by cleat (62) inserted behind web (56) holding third arm (60) within channel (54). Latch hole (64) over boss (58) completes attachment. The other third arm (60) connects to hitch housing (50) in the same manner, and is rotated rearward to engage other tongue bracket (70), and secured there by first hitch pin (68). Hinged arm assembly (22) is inserted into hitch housing (50) and engaged by second arm lock (52) in one of several second arm adjustment holes (100), forming a Y-shaped tongue as shown in FIG. 2.

Tongue assembly (24) fixed to first beam assembly (26) is manually maneuvered into position ahead of vehicle axle, sliding on skid shoes (102). Second beam assembly (28) is placed behind vehicle axle parallel with first beam assembly (26). Tapered end of first leg (82) is inserted from the front into first socket (72), extending rearward and into second socket (84). Sockets (72 & 84) have an inside width approximately 25% greater than outside width of first leg (82) allowing some transverse misalignment between beams. Tapered ends of first legs (82) provide a means to align first beam (26) and second beam (28) horizontally. First legs (80) are fixed longitudinally by second pin (80) inserted through the forward pair of second pin slots (78). Second beam (28) is pulled forward onto first legs (82) by first chain (96), secured in third chain latch (86), and using chain binder (94) also connected to anchor (74) until second beam (28) rests against wheels.

Second legs (90) extend rearward from third socket assemblies (88), second chains (98) loop through chain eyes (92) and connect wheel-lift device (20) to vehicle chassis behind the axle. First chain (96), starting from third chain latch (86), securing second beam assembly (28) approximately parallel to first beam assembly (26) by coursing through second chain latch (76). First chain (96) continues forward over a suspension or chassis component and anchored in first chain latch (66). Chain binder (94) tightens and holds wheel-lift device (20) ahead of axle making device rigid with vehicle.

Tongue forces on first beam (26) are transferred outward from tongue brackets (70) to first sockets (72). First legs (82) transfer those forces rearward to second sockets (84). Second sockets (84) further transfer torque inward on second beam assembly (28) to third socket assemblies (88). Second legs (90) transfer forces to vehicle chassis some distance behind axle.

Loaded wheel-lift device (20) is raised into towing position using hinged arm assembly (22). First arm (32) holding hitch (30) joins second arm (36) at hinge (34). Jack ram (38) is pivotally connected to first arm (32) by first clevis pin (44) and to second arm (36) by second clevis pin (46). Jack pump (40) is selectively connected to jack ram (38) using hydraulic coupler (42). Extending jack ram (38) by operating pump (40) causes first arm (32) to rotate downward on hinge (34) until straight with second arm (36). First arm lock (48) holds first arm (32) in line with second arm (36) allowing pressure to be relieved from jack ram (38). Pump (40) is separated at coupler (42) and stored. Vehicle's axle is raised into towing position by having hitch (30) connected to tow truck and wheel-lift device (20) attached to vehicle to be towed. Hitch (30) serves as a first pivot and vehicle's trailing axle as a second pivot when tongue assembly (22) rotates on first hinge (34) lifting vehicle's axle. Tow truck tows vehicle on its trailing axle.

Jack pump (40) and single-acting jack ram (38) can be replaced with truck-mounted hydraulics powering a hydraulic cylinder for raising the load after being hooked to truck. Double-acting cylinders are preferred for holding larger and heavier first arms (32) angled upward for hitching to a tow truck.

Farm and industrial equipment having a freely pivoting axle without suspension requires wedges to be used to eliminate axle movement between axle and chassis. Lateral rotation must be limited when using wheel-lift device (20) for towing.

### CONCLUSIONS, RAMIFICATIONS, AND SCOPE OF INVENTION

The present invention provides a universal wheel-lift attachment scheme for vehicles and machines having at least four wheels on two or more axles. The device will be compatible for use with most vehicles licensed for use on public highways.

This device can be especially useful for towing oversize equipment that cannot easily be hauled on trailers. Grain trucks can be used to tow grain combines across the Great Plains during harvest. Some earthmovers and wheel loaders may be towed between construction sites by dump trucks. A proper trailer hitch is the only requirement for most trucks to become tow trucks using this device.

The wheel-lift device attachment scheme, using parallel beams joining hitch arms to anchor legs, is well suited for use with larger equipment. The parallel beam wheel-lift device may be used with the largest off-road equipment, limited in size only by the weight and size of its components and the ease by which they are assembled, and by the capacity of the tow vehicle.

The wheel-lift device attachment scheme is compatible with most vehicles and heavy equipment having a sufficiently rigid frame or structure to support the attachment means described. It is expected that an axle of a vehicle usually transported on a trailer may be carried by this wheel-lift hitch without exceeding legal weight limits. Vehicles exceeding legal axle weights when towed by wreckers having conventional under-lifts can usually conform to road weight limits using this wheel-lift device.

1. A wheel-lift device forming a rigid tongue for hitching a vehicle to a tow truck, and pulling said vehicle on a trailing axle, said device comprising:
(a) a tongue assembly having a first arm hinged to a second arm, a hitch housing, and two third arms, for connecting a hitch to a first beam;
(b) said first arm, hinging on said second arm, releasable attaching said tongue assembly to said tow truck;
(c) said second arm, adjustably affixed for length within said hitch housing, connecting said first arm to said hitch housing;
(d) said third arms rigidly connecting said hitch housing to said first beam using first hitch pins;
(e) said third arms having first chain latches;
(f) said first beam having arm mounting brackets, first wheel chocks, second chain latches, first sockets for holding first legs, and slots for securing second hitch pins;
(g) said first legs for holding a second beam approximately parallel with said first beam;
(h) said second beam having second wheel chocks, third chain latches, second sockets for holding first legs in alignment, third sockets for holding second legs;
(i) said second legs, having chain eyes at end, extending rearward from said third sockets;
(j) means for releasable attaching said vehicle to said wheel-lift device for towing.

2. A rigid wheel-lift device as defined in claim 1, said first arm further comprising:
a hitch at its front for attaching to a tow truck;
a hinge at its rear connecting to said second arm and further connecting by a jack ram.

3. A rigid wheel-lift device as defined in claim 1, said second arm further comprising:
(a) a transverse hinge joining said second arm with said first arm;
(b) a jack device further joining said second arm with said first arm;
(c) a first lock for selectively holding said first arm rigidly aligned with said second arm;
(d) lock holes for releasable attaching said second arm within said hitch housing;
(e) a means for raising said vehicle for towing on its trailing axle.

4. A rigid wheel-lift device as defined in claim 1, said hitch housing further comprising:
(a) plates being of a trapezoidal shape forming the top and bottom of said housing;
(b) a second lock fixed to top plate for selectively holding said second arm at a selected length within said housing;
(c) bosses fixed within side channel of said housing;
(d) slots incorporated into side channels of said housing;
(e) a means for rigidly attaching said third arms to said housing.

5. A rigid wheel-lift device as defined in claim 1, said third arms further comprising:
(a) cleats for engaging slots within said housing;
(b) latch holes for engaging fixed bosses on said housing;
(c) first chain latches;
(d) gudgeons at rear for attaching to said first beam with first hitch pins;
(e) a means for rigidly connecting said housing to said first beam.

6. A rigid wheel-lift device as defined in claim 1, said first beam further comprising:
said first sockets and said second chain latches cooperating to hold said first leg;
a means to transfer tongue forces rearward.

7. A rigid wheel-lift device as defined in claim 1, said first legs further comprising;
(a) gudgeons at rear of said first legs, combining with said second hitch pins and said slots, securing said first legs within said first sockets;
(b) tapered at rear ends;
(c) providing a means for transferring tongue forces from said first beam to said second beam, and further for holding said beams in approximate alignment.

8. A rigid wheel-lift device as defined in claim 1, said second beam comprising:
(a) said second sockets and said third chain latches cooperating to hold said first legs;
(b) said third sockets, adjustable across said second beam, for holding said second legs;
(c) a means to transfer tongue forces from said first legs to said second legs and further rearward.

9. A rigid wheel-lift device as defined in claim 1, said second legs comprising:
said second legs extending rearward from said third sockets;
chain eyes at outer ends of said second legs for attaching to said vehicle behind its first axle.

10. A rigid wheel-lift device as defined in claim 1, wherein the attachment means comprising:
(a) first chains coursing through and connecting said chain latches;
(b) second chains connecting anchor points on said vehicle with said chain eyes fixed to said second legs;
(b) providing a means for attaching said vehicle to said rigid wheel-lift device.
